(19) United States
(12) Patent Application Publication
(10) Pub. No.: US 2012/0322408 A1
(43) Pub. Date: Dec. 20, 2012

(54) WIMAX FEMTO AND MACRO IDLE MODE AND PAGING SUPPORT FOR RE-ENTRY

(75) Inventors: Tricci So, San Diego, CA (US); Li Chu, Shenzhen (CN); Jianquan Song, Shenzhen (CN); Wen Luo, Nanjing (CN); Yangwei Tu, Nanjing (CN)

(73) Assignees: ZTE (USA) INC., Richardson, TX (US); ZTE Corporation ZTE Plaza, Shenzhen (CN)

(21) Appl. No.: 13/515,723

(22) PCT Filed: Dec. 14, 2010
(86) PCT No.: PCT/US10/60254

§ 371 Date: Aug. 27, 2012

Related U.S. Application Data
(60) Provisional application No. 61/286,299, filed on Dec. 14, 2009.

(51) Int. Cl. H04W 12/06

(52) U.S. Cl. 455/411

(57) ABSTRACT

A base station determines if the mobile station seeking re-entry into the network is a member of a closed-subscriber group associated with the base station. If the mobile station is not a member of the closed subscriber group associated with the base station, the base station redirects the mobile station to another base station.

### PRIORITY

Priority is claimed to U.S. Provisional Patent Application No. 61/286,299, filed Dec. 14, 2009, the disclosure of which is incorporated herein by reference in its entirety.

### FIELD OF THE INVENTION

The field of the present invention is wireless communication and more specifically, base station idle and paging support.

### BACKGROUND

A femto base station or wireless femto access point (“WFAP”) refers to a micro mobile communication base station that that may be connected to a mobile communication core network via a broadband network installed, typically, indoors; for example, a home or an office. A WFAP a base station (“BS”) typically covers a radius equal to or less than 10 meters. A WFAP is advantageous in that it can extend indoor coverage, improve call quality, and efficiently provide various types of wired and wireless convergence services.

In a conventional wireless cellular network, a mobile station (“MS”) may go into idle mode to save operating power if no connection is needed. When the MS goes into idle mode, a BS will give the MS paging operation parameters. The paging operation parameters may include the paging cycle, paging offset, paging group ID (“PGID”), paging MS identity and paging interval length parameters. The MS will then wake up periodically to hear the paging message from the BS in its paging cycle. The paging message may indicate specific actions to be taken by a particular MS. The actions may include network reentry from idle mode, performing location update process, and/or the like.

In recent years, WFAPs have operated in various modes, one of these being closed access mode where they provide services to only a closed subscriber group that are registered to themselves. These femto base stations are often referred to as CSG-Closed WFAPs.

The following processes are defined in the IEEE 802.16-2009 specification for macro base stations:

### Secure Location Update Process

According to the secure location update process, if the MS shares a valid security context with the target BS so that the MS may include a valid hash based message authentication code/cipher-based message authentication code (“HMAC/CMAC”) Tuple in a ranging request (“RNG-REQ”), then the MS may conduct initial ranging with the target BS by sending a RNG-REQ including Ranging Purpose Indication Type-Length-Value (“TLV”) with Bit 1 set to 1, Location Update Request and Paging Controller ID TLVs (11.1.8.2) and HMAC/CMAC Tuple.

### Unsecure Location Update Process

If the target BS does not share a current, valid security context with the MS, or if for any reason the BS has elected to instruct the MS to use Unsecure Location Update, the MS shall initiate Network Re-Entry from Idle Mode.

Network Reentry from Idle Mode

For this process, the MS shall initiate network reentry with the target BS by sending a RNG-REQ including Ranging Purpose Indication TLV with Bit 0 set to 1 and Paging Controller ID TLVs (11.1.8.2).

If the MS shares a valid security context with the target BS so that the MS may include a valid HMAC/CMAC Tuple in the RNG-REQ, then the MS shall conduct initial ranging with the target BS by sending a RNG-REQ including the HMAC/CMAC Tuple.

When an MS is seeking network reentry from idle mode, the target BS may notify the MS of reentry process management messages that may be omitted due to the availability of MS service and operational context information. To make this notification, the target BS may place a Handover (“HO”) Process Optimization TLV in the Ranging Response (“RNG-RSP”) indicating which reentry management messages may be omitted. The target BS may not direct the omission of any reentry process management messages that would compromise the security or integrity of normal operation of the communications as established through an unabridged Initial Entry.

If the MS shares a valid security context with the target BS so that the MS may include a valid HMAC/CMAC Tuple in the RNG-REQ, then the MS shall conduct initial ranging with the target BS by sending a RNG-REQ including HMAC/CMAC Tuple.

If the target BS evaluates a HMAC/CMAC Tuple included in the RNG-REQ as valid and can supply a corresponding authenticating HMAC/CMAC Tuple, then the target BS may reply with a RNG-RSP including the valid HMAC/CMAC Tuple. The target BS may not indicate through the HO Process Optimization TLV that the Privacy Key Management (“PKM”)REQ/RSP management messages may be omitted in the current reentry attempt without inclusion of a valid HMAC/CMAC Tuple. If an MS detects an invalid HMAC/CMAC Tuple included as part of a RNG-RSP during network reentry from idle mode, the MS may discard the RNG-RSP message.

Implementation of the above processes are not well defined for WFAPs, nor do they have a clear implementation path for WFAPs.

Depending on deployment configurations, each CSG-Closed WFAP may have a shared PGID with the rest of the network or may have a dedicated PGID of its own. In a shared PGID configuration, an MS performs location update process at a CSG-Closed WFAP even though it is not a member. In dedicated PGID, an MS performing location update at a CSG-Closed WFAP to which it is not a member, shall be rejected.

Once an MS is rejected by the target WFAP regarding the location update or Idle Mode re-entry due to the consideration of non-CSG membership, it is possible that the MS could continue to select the same target WFAP for the retry of network re-entry. Hence, it is more efficient for the target WFAP to provide the redirection support for the MS to a known accessible new target BS. A similar mechanism has already been specified in the Idle Mode exit procedures in the current femto draft baseline text.

The Femto subteam has agreed on the support for both the “shared” and “dedicated” PGID for WFAP paging and idle mode support. However, regardless if the WFAP support is “shared” or “dedicated” PGID support, the WFAP of which the MS is not the member of its CSG should not have access to the MS's security context (e.g. authentication key context) during the location update process and Idle Mode Exit, as this is a security concern of a WFAP's subscriber. Similarly, in topology aware paging support, there is no reason to require the femto network to page the MS when the MS is not the member of the CSG when the given WFAP is operating in the “shared mode” for the PGID support. Given the Femto-Gateway (“Fe-GW”) server awareness of the WFAP and the corresponding relationship with the given MS, WFAP in the “shared” mode does not need to page the MS that is not a member of its CSG.

In addition, the design of the NWG release-1 Femto Paging and Idle Support shall comply with not only the NWG Rel-1.0 and Rel-1.5 specifications; but also with the IEEE 802.16-2009 specification.

Accordingly, it would be advantageous to modify the existing femto draft baseline text for the Idle Mode and Paging support to ensure the more secure procedures for the non-CSG member for a given WFAP and also to be more compatible towards to the IEEE 802.16-2009 specification.

### SUMMARY OF THE INVENTION

The present invention is directed toward methods of supporting an MS during network re-entry.

In a first aspect of the present invention, a base station determines if the mobile station is a member of a closed-subscriber group associated with the base station. If the mobile station is not a member of the closed subscriber group associated with the base station, the base station instructs the mobile station to attempt network re-entry at another base station.

In a second aspect of the present invention, an MS selects a base station for network reentry, wherein the selected base station determines if the MS is not a member of the base station's closed subscriber group. If the MS is not a member of the base station's closed subscriber group, the MS receives instructions to select a different base station for network reentry.

Any of the above aspects may be implemented alone or in combination.

Additional aspects and advantages of the improvements will appear from the description of the preferred embodiment.

### DETAILED DESCRIPTION OF THE PREFERRED EMBODIMENTS

### Idle-Mode and Paging

The Fe-GW server contains the paging controller (“PC”) function. PGID allocation is a deployment choice. Depending on the deployment configurations and/or NAP sharing configurations, each CSG-Closed WFAP may have a shared PGID with the rest of the network or may have a dedicated PGID of its own.

The PGID allocation type such as “shared” or “dedicated” is configured into the WFAP by the management plane during WFAP initialization. The details of the management plane configuration can be found in WiMAX Forum Network Architecture Release 1.6—Femtocells, Part 2: Management Plane.

### Location Update at WFAP

The MS may perform the Location Update procedure when it meets the location update conditions as specified in IEEE 802.16-2009, Part 16: Air Interface for Broadband Wireless Access Systems, May 2009. The MS may use one of two processes for Location Update: Secure Location Update or Unsecure Location Update. An Un-Secure Location Update process is performed when the MS and the BS do not share a valid security context, which means that the BS is not able to receive a valid authentication key (“AK”) (e.g., the MS has crossed Mobility Domain boundaries or the PMK has expired) or when the BS otherwise elects to direct the MS to proceed with network re-entry. Un-Secure Location Update results in MS network re-entry from Idle Mode. It is performed in the same way as a regular MS network entry process.

In the event the PGID is shared and the WFAP is configured to “shared mode”, an MS should be able to perform a location update at a CSG-Closed WFAP via Secure Location Update or Unsecure Location Update, dependent on the success of the retrieval of the MS security context and the validation of the CMAC key, and if the MS is the member of the CSG of the target WFAP. When the WFAP is configured to “shared mode”, and the MS has selected the preferred target WFAP of which the MS is not the member of its CSG, the MS Location Update may be rejected, and this will lead to the MS to proceed with the re-entry procedures as described in section 5.4.4, which is based on the modification of section 4.10.2.4.4 of WiMAX Forum Network Architecture—Stage 3—Detailed Protocols and Procedures—Release1.5 (referred to hereinafter as “[1]”).

In the event the PGID is dedicated, an MS performing a Location Update (“LU”) at a CSG-Closed WFAP to which is not a member of, shall be rejected of that location update by the CSG-Closed WFAP indicating Location Update Failure in the RNG-RSP. This will lead to the MS performing network re-entry procedures as described in section 5.4.4, which is based on the modification of section 4.10.2.4.4 of [1].

### Secure Location Update Failure

The Anchor PC receiving the Location Update configuration message, including the LU Result Indicator with a value of Failure, should keep the MS information unchanged as if the Location Update procedure had not occurred. An MS receiving a RNG-RSP message with “Failure of Idle Mode Location Update” should perform a network re-entry process (see 4.10.4). If the MS is not a member of the CSG of the target WFAP, the WFAP may provide redirection to the MS to other target WFAPs/BSs in the RNG-RSP message during the network re-entry. Otherwise, the network will re-authenticate the MS during the network re-entry from Idle Mode. If the re-authentication still fails, any entity of the network which has kept any information related to the MS should not be changed.

If an MS performs a network re-entry process caused by an unsecure LU, not power down, after successful re-authentication with complete or optimized network re-entry, the Idle Mode Entry procedure may be initiated by MS or network as described in section 5.4.

If an MS performs a network re-entry process caused by an unsecure LU, power down request, after successful re-authentication with complete or optimized network re-entry, the MS or network should send a deregistration request or command to finish its power down process.

### Paging

Regardless if the PGID is shared or dedicated, the CSG-Closed WFAP may not page the non-member MSs. The paging procedure is the same as the baseline scenario described in [1] (see section 4.10.3).

### Idle-Mode Exit in WFAP

Irrespective of the PGID allocation, an MS shall be able to perform idle mode exit only in a CSG-Closed WFAP to which it is a member. In this case, the idle mode exit procedure is the same as the procedures as described in section 5.4.4, which is based on the modification of section 4.10.2.4.4 of [1]. If the MS is not a member of the CSG-Closed WFAP, then the WFAP may provide redirection to the MS to other WFAPs/BSs in the RNG-RSP message.

### Idle-Mode Entry in WFAP

An MS idle mode entry in a femtocell is the same as the baseline scenario described in [1] (see section 4.10.5).

While embodiments of this invention have been shown and described, it will be apparent to those skilled in the art that many more modifications are possible without departing from the inventive concepts herein. The invention, therefore, is not to be restricted except in the spirit of the following claims.

What is claimed is:

1. A method of supporting an MS during re-entry into a network, the method comprising:
determining if the MS is a member of a closed subscriber group associated with a first base station from a plurality of base stations; and
instructing, by the first base station, the MS to attempt re-entry into the network at another base station from the plurality of base stations in response to determining that the MS is not a member of the closed subscriber group associated with the first base station.

2. The method of claim 1, further comprising:
initiating, by the network, idle mode entry after re-authentication with the network if re-entry into the network was not caused by a power down request.

3. The method of claim 1, further comprising:
sending, by the network, a command to complete a power down process after re-authentication with the network if re-entry into the network was caused by a power down request.

4. A method of supporting an MS during re-entry into a network, the method comprising:
selecting a first base station from a plurality of base stations for re-entry into the network, wherein the first base station determines if the MS is a member of a closed subscriber group associated with the first base station; and
receiving instructions from the first base station to attempt re-entry into the network at another base station from the plurality of base stations if the MS is not a member of the closed subscriber group associated with the first base station.

5. The method of claim 4, further comprising:
initiating, by the MS, idle mode entry after re-authentication with the network if re-entry of the network was not caused by a power down request.

6. The method of claim 4, further comprising:
sending, by the MS, a command to complete a power down process after re-authentication with the network if re-entry of the network was caused by a power down request.

7. A system for supporting an MS during re-entry into a network, the method comprising:
means for determining if the MS is a member of a closed subscriber group associated with a first base station from a plurality of base stations; and
means for instructing the MS to attempt re-entry into the network at another base station from the plurality of base stations in response to determining that the MS is not a member of the closed subscriber group associated with the first base station.

8. The system of claim 7, further comprising:
means for initiating idle mode entry after re-authentication with the network if re-entry into the network was not caused by a power down request.

9. The system of claim 7, further comprising:
means for sending a command to complete a power down process after re-authentication with the network if re-entry into the network was caused by a power down request.

10. A system for supporting an MS during re-entry into a network, the method comprising:
means for selecting a first base station from a plurality of base stations for re-entry into the network, wherein the first base station determines if the MS is a member of a closed subscriber group associated with the first base station; and
means for receiving instructions from the first base station to attempt re-entry into the network at another base station from the plurality of base stations if the MS is not a member of the closed subscriber group associated with the first base station.

11. The system of claim 10, further comprising:
means for initiating idle mode entry after re-authentication with the network if re-entry of the network was not caused by a power down request.

12. The system of claim 10, further comprising:
means for sending a command to complete a power down process after re-authentication with the network if re-entry of the network was caused by a power down request.
